(19) United States
(12) Patent Application Publication
(10) Pub. No.: US 2023/0243454 A1
(43) Pub. Date: Aug. 3, 2023

(54) ANTI-ROTATION SYSTEMS FOR PUMP ACCESS COVER RETAINERS

(71) Applicant: A&W Energy, LLC, Fort Worth, TX (US)

(72) Inventor: John D. Morreale, Houston, TX (US)

(21) Appl. No.: 17/589,248

(22) Filed: Jan. 31, 2022

(51) Int. Cl. F16L 55/11; F16B 41/00

(52) U.S. Cl. CPC F16L 55/1108; F16B 41/005

(57) ABSTRACT

An anti-rotation system includes a plurality of key components, each sized and shaped to fit within and form a rotationally keyed relationship with a corresponding internal drive recess of a threaded retainer covering an access port in a fluid end of a pump; and a single locking bar that spans between and couples to each of the plurality of key components after the key components are fit within the corresponding internal drive recesses.

A method includes fitting each of a plurality of key components into a corresponding internal drive recess of a plurality of threaded retainers covering access ports in a fluid end of a pump, coupling a single locking bar to each of the plurality of key components to form an anti-rotation system; and inhibiting rotation of the plurality of threaded retainers during operation of the pump using the anti-rotation system.

### TECHNICAL FIELD

The present disclosure relates generally to well service pumps, and more particularly to systems that inhibit rotation of threaded retainers covering access ports in well service pumps. The present disclosure also relates to methods for resisting loosening or backing out of such threaded retainers from sealing engagement with the access ports.

### BACKGROUND

Well service pumps, also referred to as “hydraulic fracturing pumps”, are commonly used in oilfield operations to supply pressurized fluid downhole. Well service pumps are typically constructed as multi-cylinder reciprocating pumps with a power end and a fluid end. The power end comprises the driving assembly that operates piston plungers to reciprocate into and out of the cylinders of the fluid end of the well service pump.

### SUMMARY

In one aspect, the present disclosure is directed to an anti-rotation system that includes a plurality of key components, each sized and shaped to fit within and form a rotationally keyed relationship with a corresponding internal drive recess of a threaded retainer covering an access port in a fluid end of a pump; and a single locking bar that spans between and couples to each of the plurality of key components after the key components are fit within the corresponding internal drive recesses. In some implementations, each of the plurality of key components and each of the corresponding internal drive recesses is hex shaped. In some implementations, a front end of each of the plurality of key components and/or a face of the single locking bar that engages each of the plurality of key components may be surface textured.

The system may further include a plurality of threaded connectors, each operable to couple the single locking bar to one of the plurality of key components. In some implementations, each of the plurality of threaded connectors extends through an opening in the single locking bar aligned with a corresponding threaded hole at the rotational centerpoint of one of the plurality of key components to form a threaded connection.

The system may further include a plurality of washers, each positioned between one of the plurality of threaded connectors and the single locking bar when the single locking bar is coupled to each of the plurality of key components. In some implementations, at least one side of each of the plurality of washers is surface textured.

The system may further include a plurality of magnets, each coupled to a bottom end of one of the plurality of key components. The system may further include a plurality of threaded fasteners, each operable to couple one of the plurality of magnets to the bottom end of one of the plurality of key components. In some implementations, each of the plurality of magnets is received within a recess in the bottom end of one of the plurality of key components.

In another aspect, the present disclosure is directed to a well service pump that includes an anti-rotation system as disclosed herein.

In yet another aspect, the present disclosure is directed to a method that includes fitting each of a plurality of key components into a corresponding internal drive recess of a plurality of threaded retainers covering access ports in a fluid end of a pump, coupling a single locking bar to each of the plurality of key components to form an anti-rotation system, and inhibiting rotation of the plurality of threaded retainers during operation of the pump using the anti-rotation system. In some implementations, the fitting step further includes rotationally orienting each of the plurality of key components with a rotational orientation of the corresponding internal drive recess into which the key component is being fitted. In some implementations, the inhibiting rotation step further includes rotationally engaging each of the plurality of key components with the threaded retainer into which the key component is fitted as the threaded retainer is urged to rotate in a loosening direction, forming an attachment between the plurality of threaded retainers via the single locking bar coupled to the plurality of key components, and resisting rotation of the plurality of key components via friction between the single locking bar and the plurality of key components coupled thereto.

The method may further include coupling each of a plurality of washers to the single locking bar and to one of the plurality of key components. The method may further include increasing a coefficient of friction between the plurality of key components and the single locking bar. The method may further include self-tightening a threaded connection between one of the plurality of key components and the single locking bar. The method may further include magnetically coupling the plurality of key components with the fluid end during the fitting step.

The details of one or more implementations are set forth in the accompanying drawings and the description below. Other features, objects, and advantages of the implementations will be apparent from the description and drawings.

### BRIEF DESCRIPTION OF THE DRAWINGS

For a more complete understanding of this disclosure and its features, reference is now made to the following description, taken in conjunction with the accompanying drawings, in which:

FIG. 1 depicts a front perspective view of a representative fluid end.

FIG. 2 depicts a side cross-sectional view of the fluid end shown in FIG. 1.

FIG. 3 depicts a front perspective view of the fluid end shown in FIG. 1 and an exploded view of one implementation of an anti-rotation system according to the present disclosure before installation on the fluid end.

FIG. 4 depicts a back exploded view of the anti-rotation system shown in FIG. 3, according to the present disclosure.

FIG. 5 depicts an enlarged portion of the back exploded view of the anti-rotation system shown in FIG. 4, according to the present disclosure.

FIG. 6 depicts a front perspective view of the fluid end shown in FIG. 1 with the anti-rotation system shown in FIG. 3 installed on the fluid end.

FIG. 7 depicts a side cross-sectional view of a portion of the installed anti-rotation system shown in FIG. 6.

FIG. 8 depicts a side cross-sectional view of the fluid end shown in FIG. 6 with the anti-rotation system shown in FIG. 3 installed on the fluid end.

Like reference symbols in the various drawings indicate like elements.

### DETAILED DESCRIPTION

A well service pump may be a multi-cylinder reciprocating pump with a power end and a fluid end. The power end drives piston plungers reciprocating into and out of cylinders in the fluid end. As a result, fluid is drawn into the cylinders of the fluid end through a suction manifold and then discharged under pressure through a discharge outlet of the fluid end.

The fluid end of a well service pump includes access ports that provide access to the suction, discharge and/or cylinder components of the well service pump when service or repair is required. For normal operations, each access port is hydraulically blocked and sealed with a suction cover held in place by a threaded retainer that is threaded and torqued into compressive engagement with the cover to counteract hydraulic pressure within a cylinder of the fluid end.

During operation, a well service pump may experience significant vibrations that are inconsistent in magnitude and direction. Over time, these vibrations may promote loosening of the threaded retainer out of compressive engagement with the suction cover, and fluid leaks may occur as a result.

The present disclosure relates to systems that inhibit rotation of threaded retainers covering access ports in well service pumps. The present disclosure also relates to methods for resisting loosening or backing out of such threaded retainers from sealing engagement with the access ports.

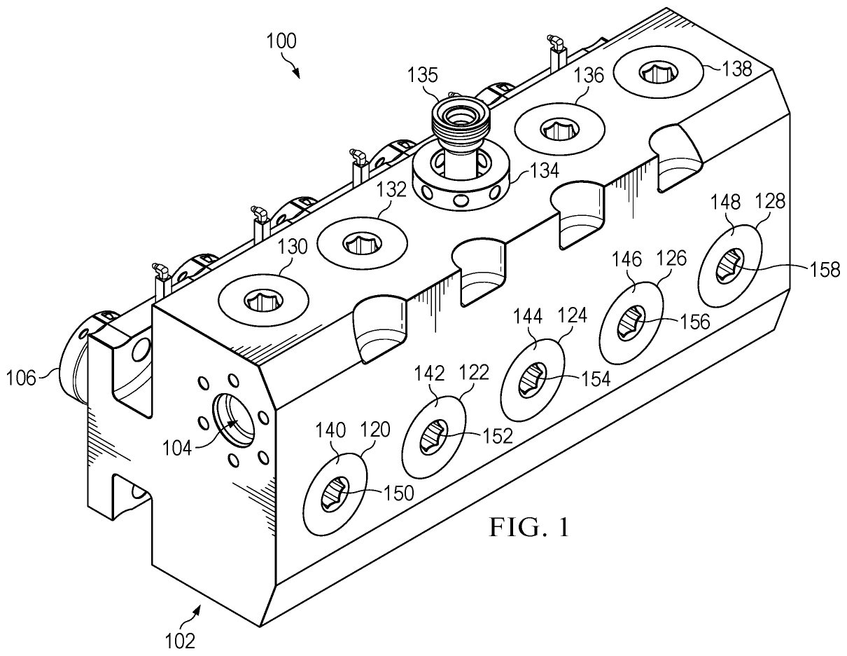

Referring now to the drawings, where like reference numerals represent like components, FIG. 1 depicts a front perspective view of a representative fluid end 100 of a five-cylinder wellfield service pump, also referred to as a quintuplex pump. A three-cylinder wellfield service pump, also referred to as a triplex pump, is also commonly used in the oilfield.

Fluid end 100 comprises a suction inlet port 102 through which fluid is drawn into the cylinders and a discharge chamber 104 through which the fluid is discharged under pressure. The fluid end 100 further comprises separate access ports 120, 122, 124, 126, 128 to each cylinder portion of the fluid end 100, and separate access ports 130, 132, 134, 136, 138 to each discharge portion of the fluid end 100. Further, the access ports 120, 122, 124, 126, 128 to each cylinder portion of the fluid end 100 are hydraulically blocked and sealed with a suction cover (internal to the fluid end 100) that is held in place by a retainer 140, 142, 144, 146, 148 that is threaded and torqued into compressive engagement with the suction cover to counteract hydraulic pressure within the cylinders of the fluid end 100. Each of the threaded retainers 140, 142, 144, 146, 148 includes an internal drive recess 150, 152, 154, 156, 158, often hex shaped, to receive a wrench for installing and removing the threaded retainers 140, 142, 144, 146, 148. A gauge connection 135 may be provided within an access port, such as within the middle access port 136 on the discharge portion of the fluid end 100 as shown in FIG. 1.

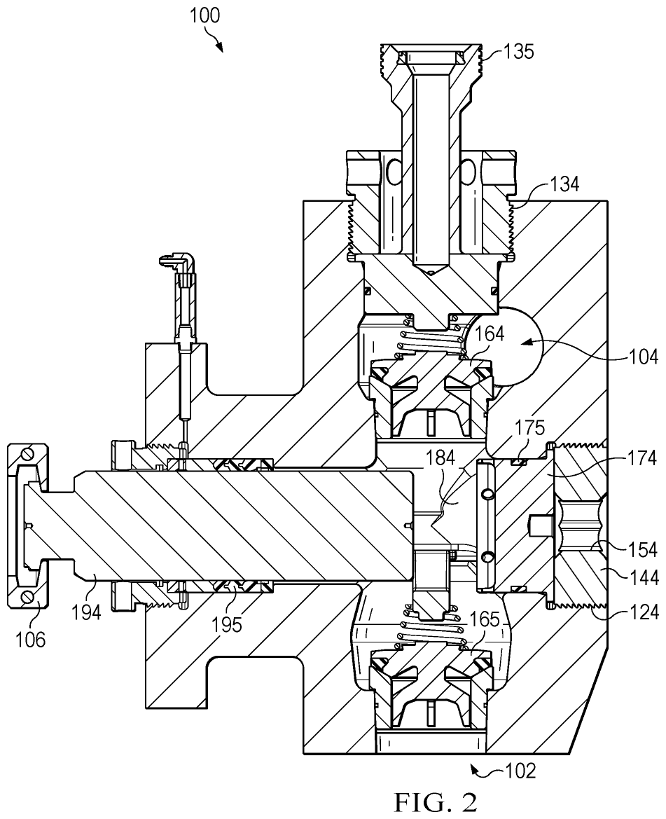

FIG. 2 depicts a side cross-sectional view of the fluid end shown in FIG. 1. As depicted, a plunger 194 includes a connection 106 for coupling to a power end of the well service pump. The power end drives the plunger 194 to reciprocate within a cylinder 184 through a dynamic hydraulic seal 195. As the power end withdraws the plunger 194 from the cylinder 184, suction is created that draws fluid from suction inlet port 102 into the cylinder 184 through suction valve 165. As the power end pushes the plunger 194 back into the cylinder 184, the fluid is discharged under pressure through the discharge valve 164 and into discharge chamber 104. The suction valve 165 and the discharge valve 164 are both one-way check valves configured to allow fluid flow into the cylinder 184 from the suction inlet port 102 and then out of the cylinder 184 through the discharge chamber 104, and to prevent flow in the opposite direction as the plunger 194 reciprocates.

As described with respect to FIG. 1, if service or repair is required, service port 124 allows access to cylinder 184, plunger 194, and suction valve 165. However, during operation, service port 124 is hydraulically blocked and sealed by a suction cover 174 and a threaded retainer 144. A seal member 175 is positioned in a circumferential groove around suction cover 174 to form a hydraulic seal with the fluid end 100 and thereby isolate cylinder 184. Threaded retainer 144 is then threaded into compressive engagement with the suction cover 174, and a wrench is inserted into internal drive recess 154 to apply a sufficient tightening torque to the threaded retainer 144 to pre-load the suction cover 174 and counteract hydraulic pressure within cylinder 184 that would otherwise force suction cover 174 out of port 124. However, during operation, the fluid end 100 may experience significant vibrations that promote loosening of the threaded retainer 144 out of compressive engagement with the suction cover 174.

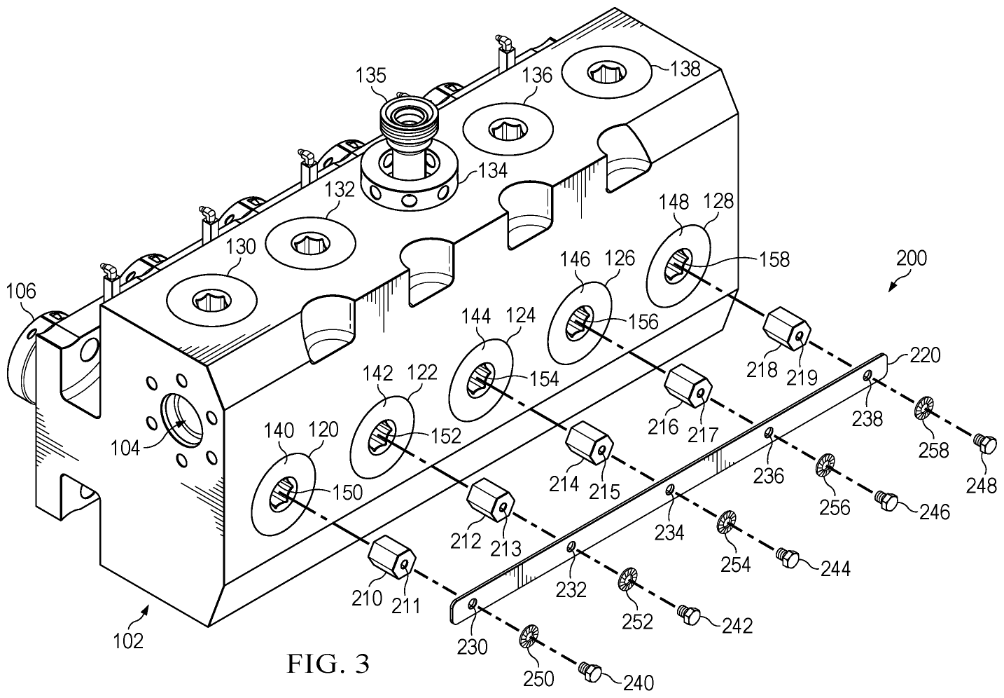

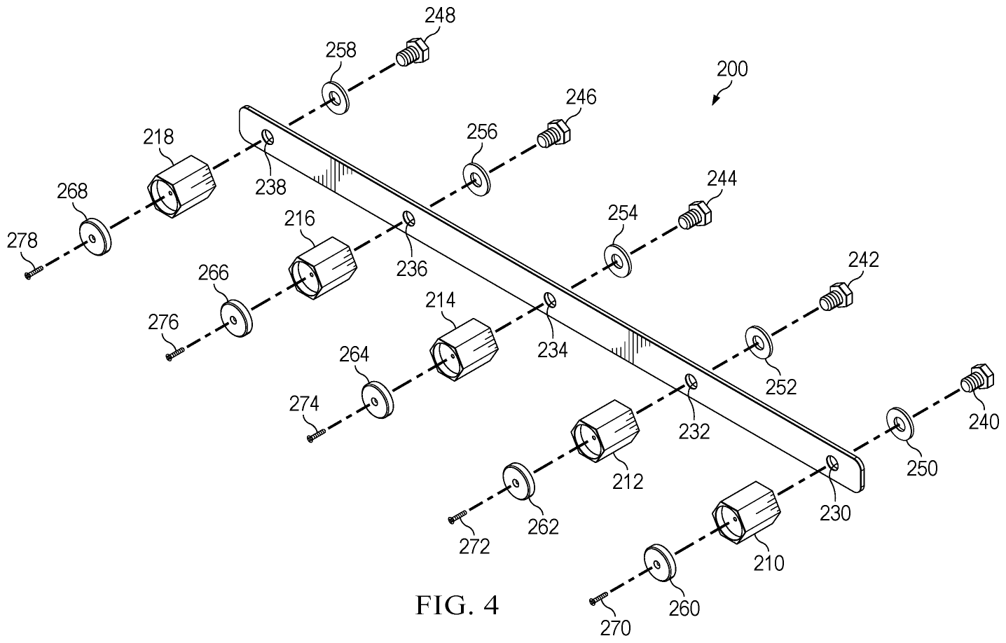

FIG. 3 depicts a front perspective view of the fluid end 100 shown in FIG. 1 as it is being fitted with an implementation of an anti-rotation system 200 according to the present disclosure. In more detail, FIG. 3 depicts the anti-rotation system 200 in a front exploded view format before installation on the fluid end 100, and FIG. 4 depicts a rear exploded view of the anti-rotation system shown in FIG. 3.

Referring first to FIG. 3, in one implementation, the anti-rotation system 200 comprises a plurality of key components 210, 212, 214, 216, 218 and a locking bar 220. Each of the key components 210, 212, 214, 216, 218 is sized and shaped to form a close fitting, rotationally keyed relationship with the corresponding internal drive recesses 150, 152, 154, 156, 158 of the threaded retainers 140, 142, 144, 146, 148. In one implementation, each of the key components 210, 212, 214, 216, 218 is hex shaped to correspond with hex shaped drive recesses 150, 152, 154, 156, 158 in the threaded retainers 140, 142, 144, 146, 148.

As depicted in FIG. 3, each of the key components 210, 212, 214, 216, 218 includes a single threaded hole 211, 213, 215, 217, 219 at its rotational center point, and the locking bar 220 includes openings 230, 232, 234, 236, 238 that are spaced to align with the single threaded holes 211, 213, 215, 217, 219 in the key components 210, 212, 214, 216, 218. The anti-rotation system 200 further comprises threaded connectors 240, 242, 244, 246, 248, such as cap screws or bolts, that extend through the openings 230, 232, 234, 236, 238 in the locking bar 220 into threaded engagement with the threaded holes 211, 213, 215, 217, 219 to couple the locking bar 220 to the key components 210, 212, 214, 216, 218. In some implementations, the anti-rotation system 200 optionally comprises a plurality of washers 250, 252, 254, 256, 258 that fit between the threaded connectors 240, 242, 244, 246, 248 and the locking bar 220 when the locking bar 220 is coupled to key components 210, 212, 214, 216, 218.

Referring now to FIG. 4, in one implementation, the anti-rotation system 200 further comprises a plurality of magnets 260, 262, 264, 266, 268 that couple with the bottom end of key components 210, 212, 214, 216, 218 via a plurality of threaded fasteners, 270, 272, 274, 276, 278, such as threaded screws or bolts.

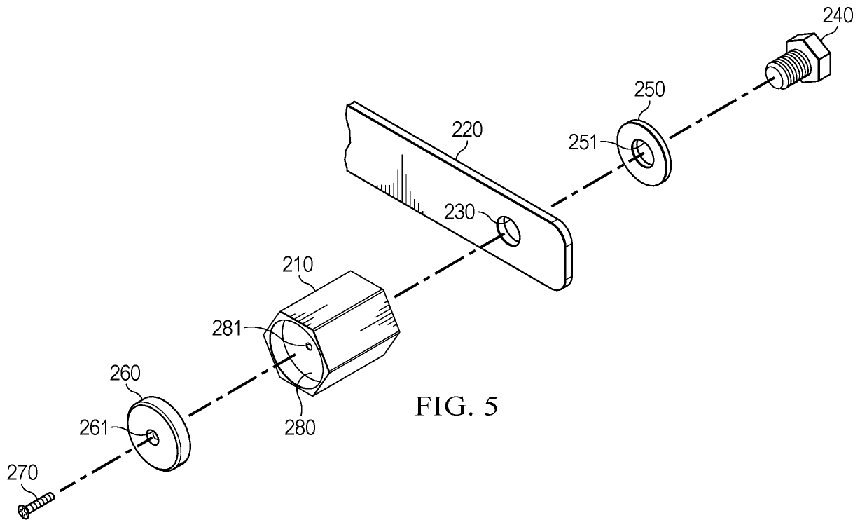

FIG. 5 depicts an enlarged portion of the back exploded view of the anti-rotation system shown in FIG. 4, according to the present disclosure. As shown in FIG. 5, the bottom end of key component 210 may include a recess 280 sized to receive the magnet 260. The key component 210 may further include a threaded hole 281 within the recess 280, and the magnet 260 may include an opening 261 that aligns with the threaded hole 281. In this implementation, the threaded fastener 270 extends through the opening 261 in the magnet 260 and into threaded engagement with the hole 281 in the key component 210 to couple the magnet 260 to the key component 210. When the anti-rotation system 200 is installed in the fluid end 100, the magnets 260, 262, 264, 266, 268 operate to magnetically couple the key components 210, 212, 214, 216, 218 to the corresponding suction covers and thereby retain the anti-rotation system 200 in place.

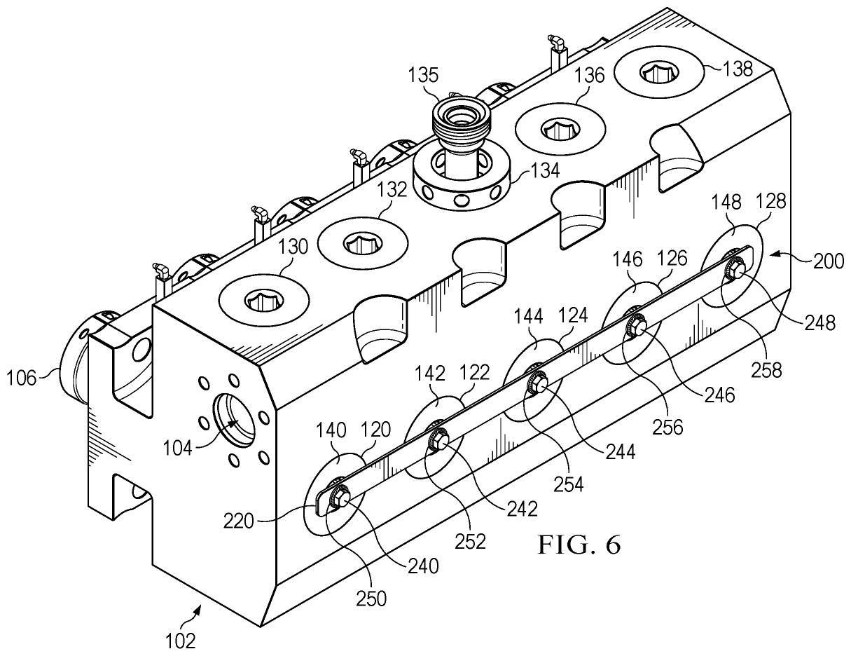

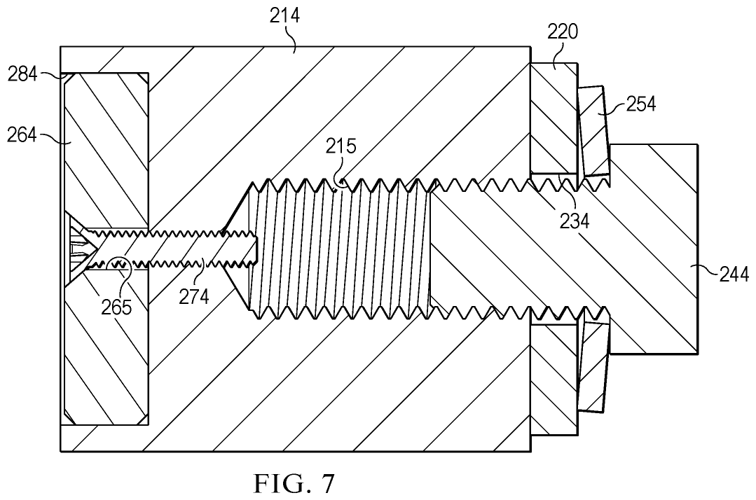

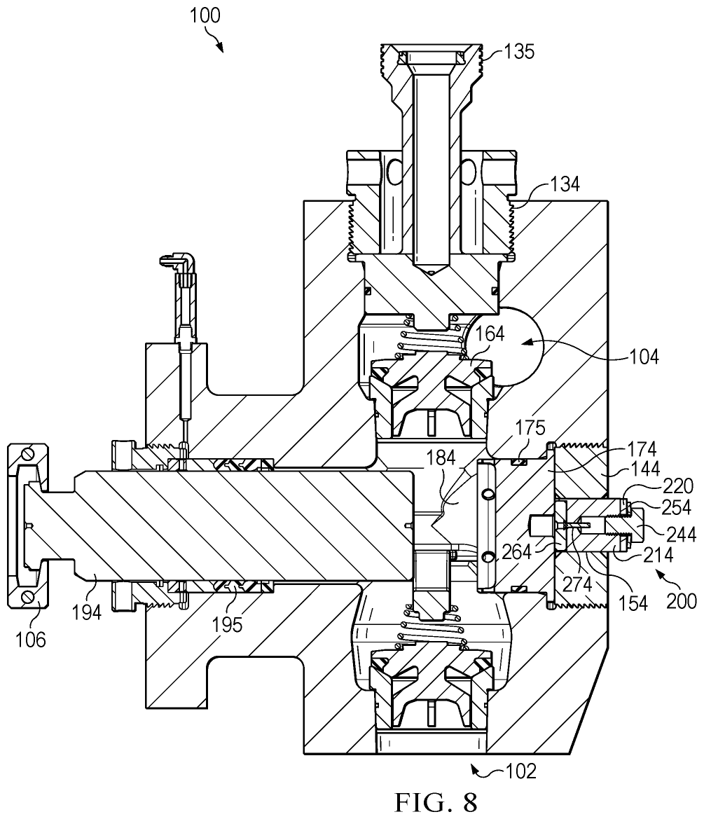

FIG. 6 depicts a front perspective view of the anti-rotation system 200 installed on the fluid end 100; FIG. 7 depicts a side cross-sectional view of a portion of the installed anti-rotation system 200 shown in FIG. 6; and FIG. 8 depicts a side cross-sectional view of the fluid end 100 shown in FIG. 6 with the anti-rotation system 200 installed. In more detail, FIG. 7 depicts a cross-sectional view of the central key component 214 of the anti-rotation device 200 and the corresponding components that are coupled to it during installation. As shown, magnet 264 is positioned within recess 284 in the bottom end of key component 214 and coupled thereto via threaded fastener 274. On the front end, the locking bar 220 is coupled to key component 214 via threaded connector 244 that threads into threaded hole 215 in the key component 214. Optionally, a washer 254 is positioned between the locking bar 220 and the threaded connector 244. FIG. 8 shows how the anti-rotation system 200 is operable to install within the internal drive recesses (recess 154) of the threaded retainers (retainer 144), and the magnets (magnet 264) magnetically couple the key components (key component 214) to the suction covers (suction cover 174) to retain the anti-rotation system 200 in place.

Referring again to FIG. 3, as the key components 210, 212, 214, 216, 218 are being inserted into the internal drive recesses 150, 152, 154, 156, 158 of the threaded retainers 140, 142, 144, 146, 148 to form a close fitting, rotationally keyed relationship, the internal drive recesses 150, 152, 154, 156, 158 may not all be rotationally aligned as shown in FIG. 3. Instead, the internal drive recesses 150, 152, 154, 156, 158 may be rotationally out of alignment with one another such that the key components 210, 212, 214, 216, 218 will need to be rotated accordingly before being inserted. Nevertheless, because each of the key components 210, 212, 214, 216, 218 includes a threaded hole 211, 213, 215, 217, 219 at its rotational center point, when the locking bar 220 is coupled across the key components 210, 212, 214, 216, 218 as depicted in FIG. 6, the angular orientation of the threaded retainers 140, 142, 144, 146, 148 does not negatively impact the function of the anti-rotation system 200. Instead, the locking bar 220 ties the multiple threaded retainers 140, 142, 144, 146, 148 together across the fluid end 100.

During operation, as the fluid end 100 experiences vibrations and the threaded retainers 140, 142, 144, 146, 148 tend to rotate in a direction that will cause them to loosen or “back out”, the key components 210, 212, 214, 216, 218 will be engaged and the retainers 140, 142, 144, 146, 148 will encounter resistance. This is due to the key components 210, 212, 214, 216, 218 being anchored by the locking bar 220 and thereby inhibited from rotating. Specifically, rotation of the key components 210, 212, 214, 216, 218 is resisted by friction between the face of the locking bar 220 and the front faces of the key components 210, 212, 214, 216, 218. If the optional washers 250, 252, 254, 256, 258 are provided, that friction is only increased. In addition, the locking bar 220 cannot rotate due to its attachment across the threaded retainers 140, 142, 144, 146, 148. Should any one of the key components 210, 212, 214, 216, 218 rotate with respect to the threaded connector 240, 242, 244, 246, 248 that couples it to the locking bar 220, that will only serve to self-tighten the connection. In more detail, the rotational direction that loosens the threaded retainers 140, 142, 144, 146, 148 is the rotational direction that tightens the threaded connectors 240, 242, 244, 246, 248, and this self-tightening force only serves to improve the anti-rotation function of the system 200.

Thus, the anti-rotation system 200 operates to resist rotation of individual threaded retainers 140, 142, 144, 146, 148 via attachment to other threaded retainers 140, 142, 144, 146, 148 and via friction between components of the anti-rotation system 200. In some implementations of the anti-rotation system 200, the coefficient of friction can be increased in various ways, such as by surface texturing the locking bar 220, surface texturing the front faces of the key components 210, 212, 214, 216, 218, and adding washers 250, 252, 254, 256, 258. Surface texturing may also be applied to the washers 250, 252, 254, 256, 258. In some implementations, surface texturing may be achieved by knurling, by roughening a surface, or by adding protrusions or ribs that deform corresponding surfaces when components engage one another.

It is to be understood the implementations are not limited to particular systems or processes described which may, of course, vary. It is also to be understood that the terminology used herein is for the purpose of describing particular implementations only, and is not intended to be limiting. As used in this specification, the singular forms “a”, “an” and “the” include plural referents unless the content clearly indicates otherwise. As another example, “coupling” includes direct and/or indirect coupling of members.

Although the present disclosure has been described in detail, it should be understood that various changes, substitutions and alterations may be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. An anti-rotation system comprising:
a plurality of key components, each sized and shaped to fit within and form a rotationally keyed relationship with a corresponding internal drive recess of a threaded retainer covering an access port in a fluid end of a pump; and
a single locking bar that spans between and couples to each of the plurality of key components after the key components are fit within the corresponding internal drive recesses.

2. The system of claim 1, wherein:
each of the plurality of key components and each of the corresponding internal drive recesses is hex shaped.

3. The system of claim 1, wherein:
a front end of each of the plurality of key components is surface textured.

4. The system of claim 1, wherein:
a face of the single locking bar that engages each of the plurality of key components is surface textured.

5. The system of claim 1, wherein:
a front end of each of the plurality of key components is surface textured; and
a face of the single locking bar that engages each of the plurality of key components is surface textured.

6. The system of claim 1, further comprising:
a plurality of threaded connectors, each operable to couple the single locking bar to one of the plurality of key components.

7. The system of claim 6, wherein:
each of the plurality of threaded connectors extends through an opening in the single locking bar aligned with a corresponding threaded hole at the rotational centerpoint of one of the plurality of key components to form a threaded connection.

8. The system of claim 6, further comprising:
a plurality of washers, each positioned between one of the plurality of threaded connectors and the single locking bar when the single locking bar is coupled to each of the plurality of key components.

9. The system of claim 8, wherein:
at least one side of each of the plurality of washers is surface textured.

10. The system of claim 1, further comprising:
a plurality of magnets, each coupled to a bottom end of one of the plurality of key components.

11. The system of claim 10, further comprising:
a plurality of threaded fasteners, each operable to couple one of the plurality of magnets to the bottom end of one of the plurality of key components.

12. The system of claim 10, wherein:
each of the plurality of magnets is received within a recess in the bottom end of one of the plurality of key components.

13. A well service pump comprising the anti-rotation system of claim 1.

14. A method comprising:
fitting each of a plurality of key components into a corresponding internal drive recess of a plurality of threaded retainers covering access ports in a fluid end of a pump;
coupling a single locking bar to each of the plurality of key components to form an anti-rotation system; and
inhibiting rotation of the plurality of threaded retainers during operation of the pump using the anti-rotation system.

15. The method of claim 14, further comprising:
coupling each of a plurality of washers to the single locking bar and to one of the plurality of key components.

16. The method of claim 14, further comprising:
increasing a coefficient of friction between the plurality of key components and the single locking bar.

17. The method of claim 14, further comprising:
self-tightening a threaded connection between one of the plurality of key components and the single locking bar.

18. The method of claim 14, further comprising:
magnetically coupling the plurality of key components with the fluid end during the fitting step.

19. The method of claim 14, wherein the fitting step further comprises:
rotationally orienting each of the plurality of key components with a rotational orientation of the corresponding internal drive recess into which the key component is being fitted.

20. The method of claim 14, wherein the inhibiting rotation step further comprises:
rotationally engaging each of the plurality of key components with the threaded retainer into which the key component is fitted as the threaded retainer is urged to rotate in a loosening direction;
forming an attachment between the plurality of threaded retainers via the single locking bar coupled to the plurality of key components; and
resisting rotation of the plurality of key components via friction between the single locking bar and the plurality of key components coupled thereto.
